(19) United States
(12) Patent Application Publication
(10) Pub. No.: US 2004/0111601 A1
(43) Pub. Date: Jun. 10, 2004

(54) System and method for the exchange of cryptographic keys

(75) Inventor: David Racz, Winchester, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/314,089

(22) Filed: Dec. 6, 2002

(51) Int. Cl. H04L 9/00

(52) U.S. Cl. 713/150

(57) ABSTRACT

A system for the exchange of cryptographic keys includes a first peer source and a second peer system. The first peer source is capable of displaying a cryptographic key adapted to at least one of encrypt and decrypt electronic information. In turn, the second peer system capable of capturing the cryptographic key. Advantageously, the second peer system is capable of capturing the cryptographic key such that a user of the second peer system is capable of visually confirming receipt of the cryptographic key from the first peer source. For example, the user can visually confirm receipt of the cryptographic key by situating the first peer source and second peer source within a field of view of a user of the second peer system as the second peer system captures the cryptographic key.

### FIELD OF THE INVENTION

The present invention relates to cryptography techniques and, more particularly, relates to systems and methods for the secure exchange of cryptographic keys for use in cryptography.

### BACKGROUND OF THE INVENTION

With the spread of electronic communication, it is becoming increasingly desirable to transmit and receive information over a secure communication channel. For example, secure communication channels are often desired to transmit and receive monetary transfers in the financial industry, to transmit and receive credit-card information in the electronic commerce industry, and to otherwise transmit and receive sensitive communications of proprietary information. Many different techniques have been utilized to establish and communicate over a secure communication channel, including many different cryptography, or data encryption, techniques.

Among the many different types of data encryption, symmetric-key and public-key cryptography are proven methods for creating secure communication channels and communicating information securely. Generally, in symmetric-key (private-key) cryptography, a shared secret (private key) is typically exchanged between the communication peers in order to secure the information to be transmitted and received. The sending peer uses the private key to encrypt the information prior to transmission to the receiving peer. The encrypted information is then transmitted to the receiving peer and, upon receipt, the receiving peer uses the same private key to decrypt the information. In this regard, only those with knowledge of the private-key can easily decrypt the encrypted information. Therefore, the private-key must be kept secret to keep the information secure.

In public-key cryptography, a receiving peer establishes a public key that has an associated private key required to decrypt information encrypted with the public key. The receiving peer maintains the private key in a private manner, but makes the public key (non-secret) key available to one or more sending peers, which can be selected in a nondiscriminatory manner. Then, a sending peer that wishes to secure information intended for the receiving peer uses the public key to encrypt the information. The encrypted information is then transmitted to the sending peer and, upon receipt, the receiving peer uses the associated private key to decrypt the information encrypted with the public key. By making the public key available to one or more sending peers in a nondiscriminatory manner, anyone with knowledge of the receiving peer's public key can send information to the receiving peer securely. However, only the receiving party, who maintains the private key, can decrypt the information.

While conventional cryptography techniques are adequate in allowing peers to communicate over a secure communications channel, such methods have drawbacks. One such drawback with conventional cryptography methods that involve the exchange of either a public or private key is in the exchange or distribution of those keys. In this regard, according to typical key exchange techniques, peers receiving the public or private key have no quick, cost efficient and reliable method of determining whether the key they receive is actually from the intended peer, particularly when the peer sending the public or private key sends the respective key to many peers. As such, during an attempted key exchange, the private key (in private-key cryptography) or the public key (in public-key cryptography) is susceptible to being intercepted and replaced with an imposter key from an third party, sometimes referred to as the “person in the middle.” In other terms, conventional cryptography methods have a drawback in that such methods do not provide for the quick, cost efficient and reliable exchange of keys in a manner that insures the integrity of the exchanged key(s).

To more fully illustrate the drawback associated with key exchange in conventional cryptography methods, consider the following scenario. In establishing a secure communications channel, first peer attempts to send a second peer a private key or a public key (depending on the type of cryptography), such as via email. As the key is being transmitted to the second peer, a person in the middle intercepts the email and replaces the key with an imposter key. The person in the middle then transmits the imposter key to the second peer under the guise of being from the first peer. Thereafter, the person in the middle is the only party that can decrypt and view information encrypted with the imposter key, as the person in the middle is the only party that can have the private key required to decrypt the encrypted information. Thus, the person in the middle can intercept, decrypt and view any information transmitted from the second peer if the second peer encrypted the information with the imposter key, regardless of whether the encrypted information was intended for the person in the middle. In addition, after decrypting the message with the imposter key, the person in the middle can use the originally transmitted public key to re-encrypt the message and send it to the first peer under the guise of being from the second peer without the security breech ever being detected by either the first or second peer.

### SUMMARY OF THE INVENTION

In light of the foregoing background, the present invention provides an improved system and method for the secure exchange of cryptographic keys, including private and public keys. The system and method of embodiments of the present invention allow a user of a device receiving the cryptographic key to visually confirm receipt of the cryptographic key from the source of the cryptographic key. In this regard, the user can visually confirm that the cryptographic key has been received from the intended source in a secure manner. The system and method of embodiments of the present invention therefore facilitate exchanging cryptographic keys without interception by unintended third parties.

According to one aspect of the present invention, a system is provided for the exchange of cryptographic keys. The system includes a first peer source and a second peer system. The first peer source is capable of displaying a cryptographic key adapted to encrypt and/or decrypt electronic information. In one embodiment, the first peer source is capable of displaying key information including the cryptographic key, such as a key information image including the cryptographic key embedded therein. More particularly, then, the first peer source can include a key generator and a key exchange element. In such embodiments, the key generator is capable of generating the cryptographic key. The key exchange element, which is electrically coupled to the key generator, can then display the cryptographic key.

The second peer system capable of capturing the cryptographic key. Advantageously, the second peer system is capable of capturing the cryptographic key such that a user of the second peer system is capable of visually confirming receipt of the cryptographic key from the first peer source. For example, the user can visually confirm receipt of the cryptographic key by situating the first peer source and second peer system within a field of view of a user of the second peer system as the second peer system captures the cryptographic key. When the cryptographic key is included within key information, the second peer system can be capable of capturing the key information such that the cryptographic key is thereafter capable of being extracted from the key information.

The second peer system can include an image capture device capable of capturing the cryptographic key or, when the first peer source displays a key information image, capturing the key information image. The image capture device can be capable of capturing an image including the cryptographic key, or key information including the cryptographic key, and at least a portion of the first peer source. In such embodiments, the user of the second peer system can visually confirm receipt of the cryptographic key from the first peer source based upon the image captured by the image capture device. Also, the second peer system can include a key processor, such as a key processor electrically coupled to the image capture device. In such instances, the key processor can be capable of processing the key information image to extract the cryptographic key from the key information image.

In one embodiment, the second peer system includes a second communication system. The second communication system can therefore encode electronic information with the cryptographic key and thereafter transmit the encrypted information. Similarly, in this embodiment, the first peer source includes a first communication system. As such, the first communication system can receive electronic information encrypted with the cryptographic key and thereafter decode the encrypted information.

A peer source and peer system, as well as a method of exchanging cryptographic keys, are also provided. Therefore, embodiments of the present invention provide an improved system and method for the secure exchange of cryptographic keys by allowing a user of the device receiving the cryptographic key to visually confirm receipt from the device displaying the cryptographic key. In this regard, the system and method of embodiments of the present invention facilitate the secure exchange of cryptographic keys. As such, the system and method of embodiments of the present invention therefore reduce the likelihood that unintended third parties can intercept the cryptographic key without being detected by the user receiving the cryptographic key. As such, the system and method of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for the exchange of cryptographic keys according to one embodiment of the present invention;

FIGS. 2A and 2B illustrate various key information images displayed by a first peer source according to one embodiment of the present invention; and

FIG. 3 is a schematic illustration of one scenario of the implementation of the system and method of one embodiment of the present invention including a vending machine and a mobile telephone.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

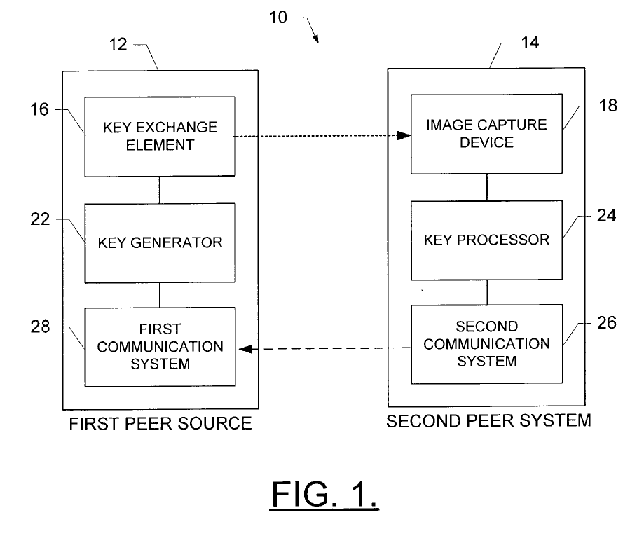

Referring to FIG. 1, according to one aspect of the present invention, a system 10 is provided for exchanging cryptographic keys adapted to encrypt and/or decrypt electronic information. The cryptographic key can be any of a number of different known types of cryptographic keys, including a public key adapted for use in public-key cryptography or a private key adapted for use in private-key cryptography. As will be appreciated by those skilled in the art, the cryptographic key can be represented in any one of a number of different manners, but typically comprises an array including a number of bits of information.

The system includes a first peer source 12 and a second peer system 14, which collectively operate to exchange the cryptographic key. In this regard, the first peer source includes a key exchange element 16 capable of displaying the cryptographic key. In turn, the second peer system includes an image capture device 18 capable of capturing the cryptographic key. Advantageously, the image capture device is capable of capturing the cryptographic key such that a user of the second peer system can visually confirm receipt of the cryptographic key from the first peer source, as described more fully below.

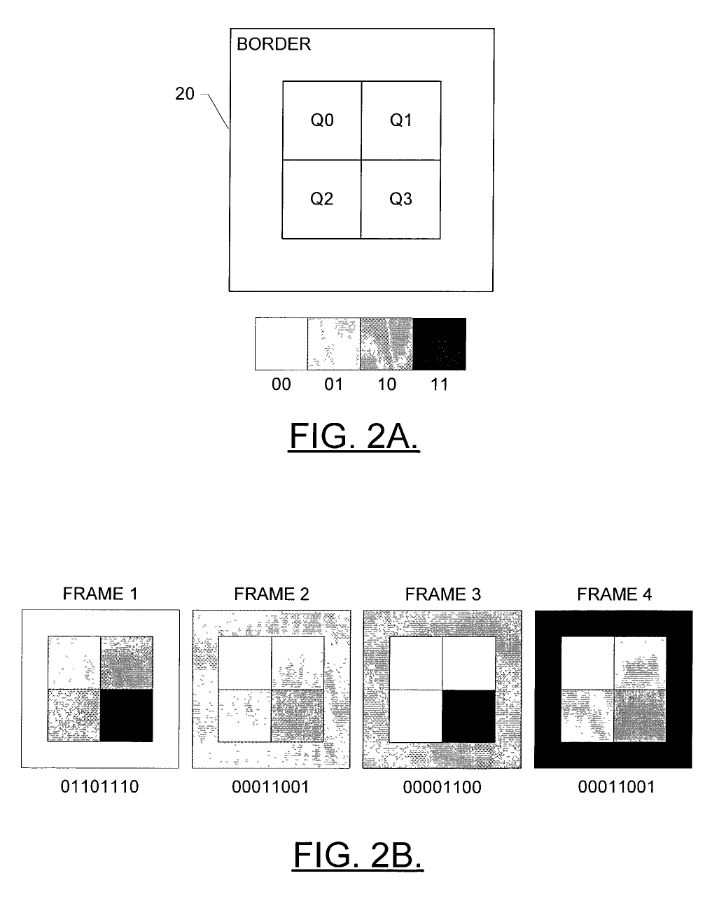

The key exchange element 16 of the first peer source 12 can display the cryptographic key in any one of a number of different manners. For example, the key exchange element can display the cryptographic key as an array of bits of information. More typically, however, the key exchange element can display the cryptographic key embedded within key information, such as within an image, referred to as a key information image. The key information can comprise any of a number of different types of information but, in one embodiment described more particularly in conjunction with FIGS. 2A and 2B, the key information comprises an image that includes one or more regions that represent one or more bits of the array that makes up the cryptographic key. As described herein, the key exchange element will be described as displaying a key information image including the cryptographic key embedded within, but it should be understood that the key exchange element can display the cryptographic key in a number of different manners.

As an illustration of one type of method of embedding the cryptographic key within key information, reference is now drawn to FIGS. 2A and 2B. It will be appreciated, however, that the key information and cryptographic key shown and described are but one type of key information and cryptographic key that can be utilized according to the present invention. In this regard, the cryptographic key can comprise any of a number of different types of cryptographic keys, and the key information can be any of number of different types of information capable of having a cryptographic key embedded therein.

As shown in FIG. 2A, one type of cryptographic key comprises an array of thirty-two bits that can be embedded within key information comprising four frames, each including eight bits of the cryptographic key embedded therein. The collection of four frames, in turn, will constitute the key information image in this example. Each frame 20 including four quadrants (designated Q1, Q2, Q3, Q4) bounded by a border. Each quadrant can then represent two bits of the cryptographic key by displaying one of four grayscale values, where each grayscale value is associated with a unique pair of bits, i.e., 00, 01, 10, 11. Similarly, the border can encrypt the sequence number of the frame, by displaying one of the four grayscale values. By so encoding the borders, then, the sequence of each frame relative to other frames can be encoded within the respective frame. To display the key information, then, the four frames can be displayed simultaneously or in succession. As an example of a thirty-two bit cryptographic key that could be embedded within the key information image, see FIG. 2B, which illustrates each of the four frames and the grayscale values representing each pair of bits in each frame.

FIGS. 2A and 2B have been shown and described as encoding a cryptographic key of thirty-two bits with key information including four frames of four quadrants, with each quadrant encoding two bits of the cryptographic key. It will be appreciated that the foregoing is but one example of a manner in which the key information can be formed and the cryptographic key embedded within the key information. For example, the cryptographic key can include more or less than thirty-two bits. Similarly, for example, the key information can include more or less than four frames, with each frame including more or less than four quadrants. In addition, for example, each quadrant can represent more or less than two bits of the cryptographic key by displaying more or fewer grayscale values, respectively. Further for example, each quadrant can represent a number of bits of the cryptographic key by displaying one or more colors, in addition to, or in lieu of, displaying grayscale values. From the foregoing examples, it will be appreciated that the cryptographic key can be embedded within the key information in any of a number of different manners, which may or may not include the display of quadrants including grayscale values or colors. For example, the key information can comprise a number of different image types, including a textual representation of the key, a barcode representation of the key, and a flashing or strobing light representation of the key.

Referring back to FIG. 1, the key exchange element 16 can comprise any of a number of different devices capable of displaying the key information image. For example, the key exchange element can comprise a printed display for displaying the key information image. In one advantageous embodiment, however, the key exchange element comprises an electronic display capable of displaying the key information image. In such embodiments, the electronic display can comprise any of a number of known electronic displays, such as a cathode ray tube (CRT), plasma display or the like. Also, the electronic display can be capable of continuously displaying the key information image or displaying the key information image at select times, such as by initiating display of the cryptographic key. In addition, or in the alternative, the electronic display can be capable of displaying the key information image interlaced between other displays. In this regard, the key information image can be interlaced at any of a number of different rates, but typically at a rate that permits the image capture device to capture the key information image. Advantageously, then, the electronic display can display the key information image such that display of the key information image is undetectable by a user viewing the electronic display, but capturable by the image capture device 18.

In addition to the key exchange element 16, the first peer source 12 can also include a key generator 22 electrically coupled to the key exchange element and capable of generating the cryptographic key. The key generator can also be capable of embedding the cryptographic key within the key information. The key generator can comprise any of a number of different devices capable of generating the cryptographic key. For example, the key generator can comprise a processing device operating according a computer program product. Alternatively, the key generator can comprise an application specific integrated circuit (ASIC) or a field programmable gate array (FPGA).

As described above, the cryptographic key can comprise any of a number of different types of cryptographic keys, such as a private key (for private-key cryptography) or a public key (for public-key cryptography). In this regard, when the cryptographic key is part of a pair of cryptographic keys that includes a public key and an associated private key (public-key cryptography), the key generator 22 can generate the public key based upon the associated private key. For example, the key generator can generate both keys such that the keys collectively make up a pair of cryptographic keys, as such is known to those skilled in the art. Although the first peer source 12 can include a key generator, it will be appreciated that the first peer source need not include a key generator. In this regard, the cryptographic key and/or key information can be provided to the key exchange element 16 in any of a number of different manners. For example, the cryptographic key and/or key information can be prestored within a memory module (not shown) of the first peer source, or the cryptographic key and/or key information can be transmitted to the first peer source via any of a number of wireline or wireless techniques, and thereafter passed to the key exchange element.

The image capture device 18 of the second peer system 14 can comprise any of a number of different devices or systems capable of capturing the key information image from the display of the key exchange element 16. In one advantageous embodiment, for example, the image capture device comprises a camera, charge coupled device (CCD) or the like capable of capturing the key information image electronically. As indicated above, the image capture device can capture the key information image such that a user of the second peer system can visually verify receipt of the key information image from the first peer source 12 or, more particularly, from the key exchange element. By capturing the key information image such that the user can visually verify receipt from the first peer source, the user can be more assured that the cryptographic key has been received by the second peer system or, more particularly, the image capture device in a manner so as to insure integrity of the cryptographic key.

The key information image can be captured to allow the user to visually verify receipt from the first peer source 12 in any number of different manners. For example, the image capture device 18 can capture an image of the key information image and at least a portion of the first peer source. In such instances, the user of the second peer system 14 can visually verify receipt of the cryptographic key from the first peer source based upon the image, such as by viewing the image as including the key information image and a portion of the first peer source. Additionally, or alternatively, for example, the first peer source and the second peer system can be situated such that both are in a field of view of the user as the image capture device captures the key information image. In such instances, the user can verify receipt of the key information image from the first peer source by viewing the display of the key information image by the key exchange element 16, and the capture of the key information image by the image capture device.

When the cryptographic key is embedded within the key information image, the key information is displayed and captured such that the cryptographic key can be extracted from the key information image. In this regard, the second peer system 14 can include a key processor 24 capable of extracting the cryptographic key from the key information image. In this regard, when the key information comprises an image (i.e., key information image), the key processor can be capable of performing image processing to extract the cryptographic key from the key information image. The key processor can comprise any of a number of different devices capable of processing the key information to extract the cryptographic key. For example, the key processor can comprise a processing device operating according a computer program product (e.g., an image processing software product). Alternatively, the key processor can comprise an ASIC or a FPGA.

It will be appreciated, however, that the second peer system 14 need not include a key processor 24 to extract the cryptographic key from the key information. In embodiments in which the second peer system does not include a key processor, the key information can be transmitted from the second peer system to an external processor (not shown) that can thereafter extract the cryptographic key. In such instances, the key information can be transmitted in any of a number of different manners, such as via a fixed or removable memory module (not shown) of the second peer system, or via any of a number of wireline or wireless transfer techniques, as such are known.

After the cryptographic key has been extracted from the key information, the cryptographic key can be utilized to encrypt electronic information. The electronic information can be encrypted and transmitted by one or more devices or systems capable of encrypting electronic information and transmitting the encrypted information. Similarly, the encrypted information can be received and decrypted by one or more devices or systems capable of receiving encrypted information and decrypting the encrypted information into electronic information. In this regard, the encrypted information can be decrypted utilizing a copy of the cryptographic key when the cryptographic key comprises a private key (private-key cryptography), or utilizing an associated private key when the cryptographic key comprises a public key (public-key cryptography).

In one embodiment, the second peer system 14 includes a second communication system 26 capable of encoding electronic information with the cryptographic key and thereafter transmitting the encrypted information. Similarly, in one embodiment, the first peer source 12 includes a first communication system 28 capable of receiving encrypted information and thereafter decrypting the encrypted information into the original electronic information. The electronic information can be encrypted and decrypted by the respective communication systems according to any of a number of well known cryptography techniques. Similarly, the encrypted information can be transmitted and received according to any of a number of well known techniques. For example, in one embodiment, the encrypted information is transmitted and received over a mobile communications network communicating according to any of a number of well known standards, such as the Global System for Mobile (GSM) communications standard, the Code Division Multiple Access (CDMA) communications standard or any of their progeny and the like.

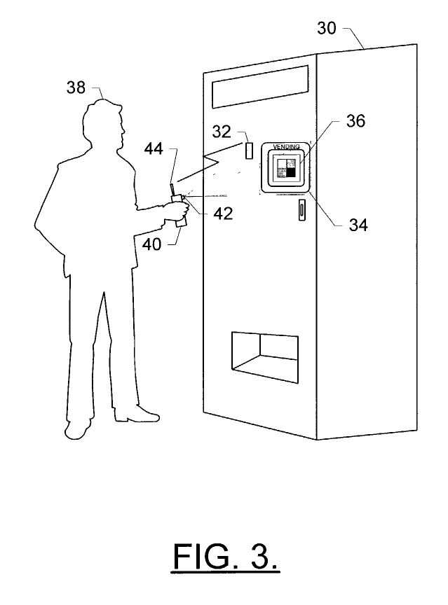

As is apparent, the first peer source 12 and the second peer system 14 can comprise any of a number of different sources and systems capable of operating according to embodiments of the present invention. For example, the first peer source and/or second peer system can comprise a mobile source and/or system, respectively, such as mobile telephones, personal digital assistants (PDAs), pagers, laptop computers or the like. Alternatively, the first peer source and/or the second peer system can comprise a stationary source and/or system, respectively, such as landline telephones, facsimile machines, personal computers, server computers or the like. In embodiments where the first peer source and/or second peer system comprise a stationary source and/or system, respectively, the first peer source and/or second peer system can be included within a commercial system, such as within a kiosk, express check-out station or a vending machine. Thus, to more fully illustrate a scenario of operation of the system 10 according to one embodiment of the present invention, reference is drawn to FIG. 3.

As shown in FIG. 3, the first peer source comprises a vending machine 30 that can sell any of a number of conventional items. The vending machine operates by receiving value, such as monetary value, receiving a selection of at least one item, and thereafter dispensing the selected items. The vending machine can receive value in any of a number of different manners but, according to embodiments of the present invention, the vending machine can receive value electronically. For example, the vending machine can receive value by receiving credit-card information, such as via radio frequency (RF) transmission to a receiver 32, such as may be included within a first communication system 28.

To securely transmit value to the vending machine 30, such as via RF transmission, it would be desirable to encrypt electronic information representative of the value (e.g., credit card information). Thus, to securely receive a cryptographic key from the vending machine 30, the vending machine includes an electronic display 34 (i.e., key exchange element). The electronic display, in turn, can display a key information image 36, such as is described above. For example, the vending machine may sequentially or simultaneously display the four frames shown in FIG. 2B that collectively define the key information image. Additionally, the electronic display can also display an identifier associated with the vending machine (shown as comprising the identifier “Vending”), such as a name of the vending machine.

In operation, a user 38 of an electronic device (i.e., user of the second peer system 14), such as a mobile telephone 40 (i.e., second peer system), approaches the vending machine to purchase an item from the vending machine. In this regard, the mobile telephone includes a camera 42 capable of capturing images. To securely receive the cryptographic key from the vending machine, then, the user operates the mobile telephone to capture the key information image 36. If the vending machine and the mobile telephone are both within the field of view of the user as the vending machine displays the key information image and the mobile telephone captures the key information image, the user can visually confirm that the mobile telephone received the key information image and, thus, the cryptographic key, from the vending machine. Additionally, or alternatively, the user can operate the mobile telephone to capture an image of the entire electronic display, including the key information image and the identifier associated with the vending machine. By capturing an image of both the key information image and the identifier, the user can visually verify receipt of the key information image, and therefore the cryptographic key, from the vending machine based on the image captured. This feature is certainly advantageous in instances in which the user is remote from and not in visible contact with the first peer source, such as embodiments in which the first peer source and the second peer system communicate via a computer or telecommunications network.

Once the mobile telephone 40 has captured the key information image, the mobile telephone processes the key information image, such as in a key processor 24 to extract the cryptographic key. Thereafter, a second communication system 26 within the mobile telephone can use the cryptographic key to encrypt the electronic information representative of the value. Thereafter, the mobile telephone can transmit the encrypted information, such as via an antenna 44 (as such could be included within the second communication system), to the receiver 32 of the vending machine. Upon receipt of the encrypted information, the vending machine can then decrypt the electronic information representative of the value, process the information and thereafter dispense the desired item.

As shown and described herein, the first peer source 12 includes a key exchange element 16 and a key generator 22, and the second peer system 14 includes an image capture device 18 and a key processor 24. It should be appreciated that the first peer source can include an image capture device and a key processor. In such instances, the first peer source can be capable of receiving key information having an embedded cryptographic key and processing the key information, as well as displaying key information. Similarly, the second peer source can include a key exchange element and a key generator. As such, the second peer source can be capable of generating key information, including a cryptographic key, and displaying the key information. Thus, the first peer source and the second peer system can communicate bidirectionally in an encrypted fashion.

Further, although as shown the second communication system 26 of the second peer system 14 transmits encrypted information to the first communication system 28 of the first peer source 12, it should be appreciated that the second communication system need not transmit the encrypted information to the first peer source. In this regard, the second communication system can transmit the encrypted information to any element, device or system capable of receiving the encrypted information and, directly or indirectly, decrypting the encrypted information. Similarly, the first peer source need not receive encrypted information from the second peer system. The first peer source can receive encrypted information from any element, device or system capable of transmitting the encrypted information.

Therefore, embodiments of the present invention provide an improved system and method of exchanging cryptographic keys. The system and method allow a user of a device receiving the cryptographic key to visually confirm receipt of the cryptographic key from the source of the cryptographic key. The user can therefore visually confirm that the cryptographic key has been received from the intended source in a secure manner. As such, the system and method of embodiments of the present invention facilitate exchanging cryptographic keys without interception by unintended third parties. In this regard, the system and method of embodiments of the present invention solve the drawbacks of conventional key exchange techniques, while providing additional advantages.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for the exchange of cryptographic keys comprising:
a first peer source capable of displaying a cryptographic key adapted to at least one of encrypt and decrypt electronic information; and
a second peer system capable of capturing the cryptographic key, wherein the second peer system captures the cryptographic key such that a user of the second peer system is capable of visually confirming receipt of the cryptographic key from the first peer source.

2. A system according to claim 1, wherein the first peer source is capable of displaying key information including the cryptographic key, wherein the second peer system is capable of capturing the key information such that the cryptographic key is thereafter capable of being extracted from the key information.

3. A system according to claim 2, wherein the key information comprises a key information image that includes the cryptographic key embedded within the key information image, and wherein the second peer system includes an image capture device capable of capturing the key information image.

4. A system according to claim 3, wherein the second peer system includes a key processor electrically coupled to the image capture device, wherein the key processor is capable of processing the key information image to extract the cryptographic key from the key information image.

5. A system according to claim 1, wherein the second peer system includes an image capture device capable of capturing an image including the cryptographic key and at least a portion of the first peer source, and wherein a user of the second peer system is capable of visually confirming receipt of the cryptographic key from the first peer source based upon the image captured by the image capture device.

6. A system according to claim 5, wherein the first peer source is capable of displaying key information including the cryptographic key, wherein the second peer system is capable of capturing an image including the key information and at least a portion of the first peer source, and wherein the image is captured such that the cryptographic key is thereafter capable of being extracted from the key information.

7. A system according to claim 1, wherein the first peer source comprises:
a key generator capable of generating the cryptographic key; and
a key exchange element electrically coupled to the key generator, wherein the key exchange element is capable of displaying the cryptographic key.

8. A system according to claim 1, wherein the second peer system includes a second communication system capable of encoding electronic information with the cryptographic key and thereafter transmitting the encrypted information, and wherein the first peer source includes a first communication system capable of receiving electronic information encrypted with the cryptographic key and thereafter decoding the encrypted information.

9. A system according to claim 1, wherein the first peer source and second peer source are within a field of view of a user of the second peer system as the second peer system captures the cryptographic key.

10. A method of exchanging cryptographic keys comprising:
displaying a cryptographic key adapted to at least one of encrypt and decrypt electronic information, wherein the cryptographic key is displayed from a first peer source; and
capturing the cryptographic key such that receipt of the cryptographic key from the first peer source is visually confirmable.

11. A method according to claim 10, wherein displaying the cryptographic key comprises displaying key information including the cryptographic key, and capturing the cryptographic key comprises capturing the key information such that the cryptographic key is thereafter capable of being extracted from the key information.

12. A method according to claim 11, wherein displaying key information comprises providing a key information image that includes the cryptographic key embedded within the key information image, and wherein capturing the key information comprises capturing the key information image.

13. A method according to claim 10, wherein capturing the cryptographic key comprises capturing an image including the cryptographic key and at least a portion of the first peer source, and wherein receipt of the cryptographic key from the first peer source is visually confirmable based upon the image captured.

14. A method according to claim 13, wherein displaying the cryptographic key comprises displaying key information including the cryptographic key, wherein capturing an image including the cryptographic key comprises capturing an image including the key information and at least a portion of the first peer source such that the cryptographic key is thereafter capable of being extracted from the key information.

15. A method according to claim 10, wherein capturing the cryptographic key comprises capturing the cryptographic key with a second peer system, and wherein capturing the cryptographic key comprises capturing the cryptographic key such the first peer source and second peer system are within a field of view of a user of the second peer system as the cryptographic key is captured.

16. A peer source for providing a cryptographic key, the peer source comprising:
a key generator capable of generating a cryptographic key adapted to at least one of encrypt and decrypt electronic information; and
a key exchange element electrically coupled to the key generator, wherein the key exchange element is capable of displaying the cryptographic key such that the cryptographic key is capable of being detected by a second peer system, and wherein the cryptographic key is displayed such that a user of the second peer system is capable of visually confirming receipt of the cryptographic key from the first peer source.

17. A peer source according to claim 16, wherein the key exchange element is capable of displaying key information including the cryptographic key such that the key information is capable of being captured by the second peer system and thereafter processed to extract the cryptographic key from the key information.

18. A peer source according to claim 17, wherein the key exchange element is capable of displaying the key information comprising a key information image that includes the cryptographic key embedded within the key information image.

19. A peer source according to claim 16, wherein the key exchange element is capable of displaying the cryptographic key such that an image including the cryptographic key and at least a portion of the peer source is capable of being captured by the second peer system, and wherein the key exchange element is capable of displaying the cryptographic key such that a user of the second peer system is capable of visually confirming receipt of the cryptographic key from the first peer source based upon the image captured.

20. A peer source according to claim 19, wherein the key exchange element is capable of displaying key information including the cryptographic key such that an image including the key information and at least a portion of the first peer source is capable of being captured by the second peer system and thereafter processed to extract the cryptographic key from the key information.

21. A peer source according to claim 16 further comprising a communication system capable of receiving electronic information encrypted with the cryptographic key and thereafter decoding the encrypted information.

22. A peer source according to claim 16, wherein the key exchange element is capable of displaying the cryptographic key such that the key exchange element and second peer system are located within a field of view of a user of the second peer system as the second peer system captures the cryptographic key.

23. A peer system for receiving a cryptographic key, the system comprising:
an image capture device capable of capturing a cryptographic key adapted to at least one of encrypt and decrypt electronic information, wherein the image capture device is capable of capturing the cryptographic key displayed by a first peer source, wherein the image capture device is capable of capturing the cryptographic key such that a user of the peer system is capable of visually confirming receipt of the cryptographic key from the first peer source.

24. A peer system according to claim 23, wherein the first peer source is capable of providing key information including the cryptographic key, wherein the image capture device is capable of capturing key information displayed by the first peer source, wherein the key information includes the cryptographic key, and wherein the image capture device is capable of capturing the key information such that the cryptographic key is thereafter capable of being extracted from the key information.

25. A peer system according to claim 24, wherein the key information comprises a key information image that includes the cryptographic key embedded within the key information image, and wherein the image capture device is capable of capturing the key information image.

26. A peer system according to claim 25 further comprising a key processor electrically coupled to the image capture device, wherein the key processor is capable of processing the key information image to extract the cryptographic key from the key information image.

27. A peer system according to claim 23, wherein the image capture device is capable of capturing an image including the cryptographic key and at least a portion of the first peer source, and wherein a user of the peer system is capable of visually confirming receipt of the cryptographic key from the first peer source based upon the image captured by the image capture device.

28. A peer system according to claim 27, wherein the image capture device is capable of capturing an image including key information and at least a portion of the first peer source, wherein the key information includes the cryptographic key, and wherein the image is captured such that the cryptographic key is thereafter capable of being extracted from the key information.

29. A peer system according to claim 23 further comprising a communication system capable of encoding electronic information with the cryptographic key and thereafter transmitting the encrypted information.

30. A peer system according to claim 23, wherein the image capture device is capable of capturing the cryptographic key such that the image capture device and the first peer source are within a field of view of the user of the second peer system as the second peer system captures the cryptographic key.
